(19) United States
(12) Patent Application Publication
(10) Pub. No.: US 2017/0259291 A1
(43) Pub. Date: Sep. 14, 2017

(54) COUPLING STRUCTURE OF SPRAY HEAD AND CONNECTOR OF WATER SPRAY GUN

(71) Applicant: Yu Chung Liao, Taichung (TW)

(72) Inventor: Yu Chung Liao, Taichung (TW)

(21) Appl. No.: 15/066,025

(22) Filed: Mar. 10, 2016

(51) Int. Cl. B05B 15/06; F16L 39/00; F16L 27/08; B05B 9/01; B05B 1/16

(52) U.S. Cl. CPC B05B 15/065; B05B 9/01; B05B 1/169; F16L 27/08; F16L 39/00

(57) ABSTRACT

A coupling structure of a spray head and a connector of a water spray gun is provided. An outer wall of the connector is provided with a positioning flange. The rear end of the spray head is provided with a stop plate. The rear end of the spray head is provided with a positioning rim. When the connector is inserted into the accommodation space of the spray head, the stop plate is secured in the positioning rim and connected with the rear end of the spray head. The stop plate has an annular area to get contact with the positioning flange provided on the outer wall of the connector, such that the spray head and the connector are assembled to become one-piece. The size of the spray head is reduced, so it is light and cost-effective. The water spray gun is able to provide different spray modes.

### BACKGROUND OF THE INVENTION

1. Field of the Invention

The present invention relates to a coupling structure of a spray head and a connector of a water spray gun, and more particularly to a water spray gun able to provide different spray modes with a reduced spray head which is light and cost-effective.

2. Description of the Prior Art

A conventional water spray gun, as shown in FIG. 1 of U.S. Pat. No. 6,113,009, comprises a handle 1 and a main body 11, with a connected water channel 12 inside the main body. A valve rod 13 is provided inside the water channel 12. The end of the valve rod 13 extends out of the main body and is screwedly connected with a press board 14. The front end of the water channel 12 is a narrowed valve mouth 15. The valve rod 13 is configured to close the valve mouth 15 so that water pressure in the water channel 12 cannot go through a water outlet 16. When the valve rod 13 is pressed by the press board 14 to retreat, water pressure in the water channel 12 will go through the water outlet 16. A spray head 17 is provided with a plurality of nozzles arranged circularly. In general, the spray head 17 has four nozzles 171 which are different from each other in shape, such as an oblique fan shape, a water pillar shape, a flat fan shape, or a flared shape for providing different spray modes. The spray head 17 uses a screw 18 to pierce through a coupling hole and connect with a center post 181 of the main body 11. The main body 11 is provided with a positioning structure 19. The inner wall of the spray head 17 is formed with a positioning groove 172. When the spray head 17 is rotated, the positioning groove 172 corresponds to the positioning structure 19 of the main body 11 for one of the nozzles 171 of the spray head 17 to align with the water outlet 16. Although the structure of this conventional water spray gun is very simple and able to generate different spray modes, it still has some drawbacks.

First of all, the spray head 17 needs the screw 18 to pierce through the coupling hole and connect with the center post 181 of the main body 11, so that the spray head 17 is connected with the main body 11. On one hand, if the screw 18 is screwed too tight, the spray head 17 cannot be rotated smoothly for one of the nozzle 171 to align with the water outlet 16. On the other hand, if the screw 18 is too loose, the nozzle 171 of the spray head 17 cannot contact tightly with the water outlet 16 so that all of the water pressure cannot get into the nozzle 171 and some will spill out.

Next, the spray head 17 is screwedly connected to the main body 11 by means of the screw 18. However, after a long time of use that the spray head 17 is turned to align one of the nozzles 171 with the water outlet 16, the spray head 17 may not tightly hold contact with the water outlet 16. As a result, the water spray gun will be scrapped.

In addition, the water spray gun must be provided with the center post 181 inside the main body 1, and the spray head 17 with the nozzles 171 must have the central coupling hole for the screw 18 to penetrate through the coupling hole of the spray head 17 and connect with the center post 181 of the main body 1, such that the spray head 17 and the main body 1 are assembled. Except the nozzles 171, the spray head 17 must be formed with the coupling hole 18 for insertion of the screw 18. The coupling hole is disposed at the center of the spray head 17, which results in that the nozzles 171 cannot be disposed toward the center of the spray head 17. The spray head 17 and the main body 1 cannot be reduced in size. The water spray gun uses more material and is heavier. The material cost cannot be lowered, so the water spray gun needs improving.

Another conventional water spray gun, as shown in FIG. 2A and FIG. 2B of U.S. Pat. No. 6,113,009, comprises a spray head 26, a connector 27, and a main body 21. The spray head 26 is provided with nozzles 261 arranged circularly. The nozzles 261 each have a wall surface extending inward. The edge of the inner wall surface of the spray head 26 is formed with a plurality of convex retaining portions 262 which are equally spaced. The connector 27 has a water channel 271 therein. The water channel 271 is narrowed at a proper position to form a valve mouth 272. The connector 27 further has a water outlet 273 which deviates from the center line of the connector and extends to one side of the partition 274. The diameter of the partition 274 is slightly greater than that of the coupling seat 211 of the main body 21 and equal to the inner diameter of the spray head 26. The partition 274 has a washer groove 275 to receive a washer 276 so as to prevent leaking. The front end of the coupling seat 211 of the main body 21 is provided with an engaging ring 212 having a curved side. The main body 21 has a positioning hole 213 under the coupling seat 211. The spray head 26 is pushed to connect with the coupling seat 211 of the main body 21, and the retaining portions 262 of the spray head 26 pass through the curved side of the engaging ring 212 of the coupling seat 211 to be engaged. The spray head 26 is limited to and positioned by the engaging ring 212. The spray head 26 is rotatable, and the connector 27 is confined within the main body 21 by the spray head 26. The spray head 26 is turned for the water outlet to align with one of the nozzles 216 to spray water. The spray head 26 can be provided with a mesh 264 to provide another spray model.

First, the retaining portions 262 at the edge of the inner wall of the spray head 26 are equally spaced in order to engage with the engaging ring 212 on the coupling seat 211. Each retaining portion 262 is slightly raised inward from the inner wall of the spray head 26 and the engaging ring 212 of the coupling seat 211 is also slightly curved, such that the spray head 26 can be pushed to the coupling seat 211 of the main body 21 for the retaining portions 262 of the spray head 26 to pass through the curved side of the engaging ring 212 on the coupling seat 211 to be engaged. The spray head 26 is limited to and positioned by the engaging ring 212. The spray head 26 is rotatable. The contact area of the retaining portions 26 of the spray head 26 and the engaging ring 212 of the coupling seat 211 is quite limited. Through the engaging portions 262 of the spray head 26 to engage with the engaging ring 212 of the coupling seat 211, the spray head 26 can be rotated to adjust the nozzles 261 for different spray modes. After the spray head 26 and the coupling seat 211 of the main body 21 are rotated many times, the retaining portions 262 of the spray head 26 and the engaging ring 212 of the coupling seat 211 will suffer a lot of wear and tear to be loose. As a result, the water outlet 273 of the connector 26 cannot get contact with the nozzles 261 of the spray head 26 tightly. The water pressure from the water outlet 273 cannot enter the nozzles 261 totally.

Secondly, the retaining portions 262 of the spray head 26 are disposed at the edge of the inner wall of the spray head 26, and the spray head 26 is further provided with the nozzles 261 arranged circularly. That is to say, the retaining portions 262 are located around the outer periphery of the nozzles 261 of the spray head 26 to engage with the engaging ring 212 of the coupling seat 211. The spray head 26 must be provided with the nozzles 261 arranged circularly as well as the engaging portions 262 around the outer periphery of the nozzles 261 so as to engage with the engaging ring 212 of the coupling seat 211. The spray head 26 and the coupling seat 211 of the main body 21 cannot be reduced in size. The water spray gun uses more material and is heavier. The material cost cannot be lowered, so the water spray gun needs improving.

Accordingly, the inventor of the present invention has devoted himself based on his many years of practical experiences to solve these problems.

### SUMMARY OF THE INVENTION

The primary object of the present invention is to improve the shortcomings of the foregoing structure and provide a coupling structure of a spray head and a connector of a water spray gun. A front end of the spray head is connected with a circular plate. A central portion of the circular plate is provided with a plurality of spray holes which are arranged circularly and provide different spray modes. A rear side of the circular plate is formed with positioning recesses disposed at an outer side of each spray hole. A rear end of the spray head is formed with an accommodation space therein. A front section of the connector is inserted from the rear end of the spray head into the accommodation space. The connector has a water channel space therein for communicating with a water source. A front end of the connector has a water outlet and a positioning hole. The water outlet is sleeved with an elastic O-shaped sealing ring and in communication with the water channel space. The positioning hole is configured to receive a positioning pin. The positioning pin is engaged in one of the positioning recesses at the rear side of the spray head. An outer wall of the connector is provided with a positioning flange. The rear end of the spray head is provided with a stop plate. The rear end of the spray head is further provided with a positioning rim. When the connector is inserted into the accommodation space at the rear end of the spray head, the stop plate is secured in the positioning rim and connected with the rear end of the spray head. The stop plate has an annular area to get contact with the positioning flange provided on the outer wall of the connector, such that the spray head and the connector are assembled to become one-piece. The size of the spray head is reduced, so it is light and cost-effective. The water spray gun is able to provide different spray modes.

Another object of the present invention is to provide a coupling structure of a spray head and a connector of a water spray gun, wherein the stop plate is fixed to the rear end of the spray head to limit the positioning flange provided on the outer wall of the connector, enabling the front section of the connector to be inserted and positioned in the accommodation space at the rear end of the spray head to become one-piece. Thus, the size of the spray head is reduced, so it is light and cost-effective. The circular plate of the spray head is formed with the spray holes to provide different spray modes.

A further object of the present invention is to provide a coupling structure of a spray head and a connector of a water spray gun, wherein the stop plate is fixed to the rear end of the spray head and has an annular area to get contact with the positioning flange provided on the outer wall of the connector. When the spray head is rotated relative to the connector, one of the spray holes arranged at the central portion of the circular plate is aligned with the water outlet of the connector and in contact with the elastic O-shaped sealing ring so as to guide the water to spray out through the spray hole of the spray head.

### BRIEF DESCRIPTION OF THE DRAWINGS

FIG. 1 is an exploded view of a coupling structure of a spray head and a connector of a water spray gun of the present invention;

FIG. 2 is a perspective view of FIG. 1;

FIG. 3 is an exploded view of the present invention seen from another angle;

FIG. 4 is a perspective view of FIG. 3;

FIG. 5 is a schematic view of the present invention when in use; and

FIG. 6 is a partially enlarged sectional view of FIG. 5.

### DETAILED DESCRIPTION OF THE PREFERRED EMBODIMENTS

Embodiments of the present invention will now be described, by way of example only, with reference to the accompanying drawings.

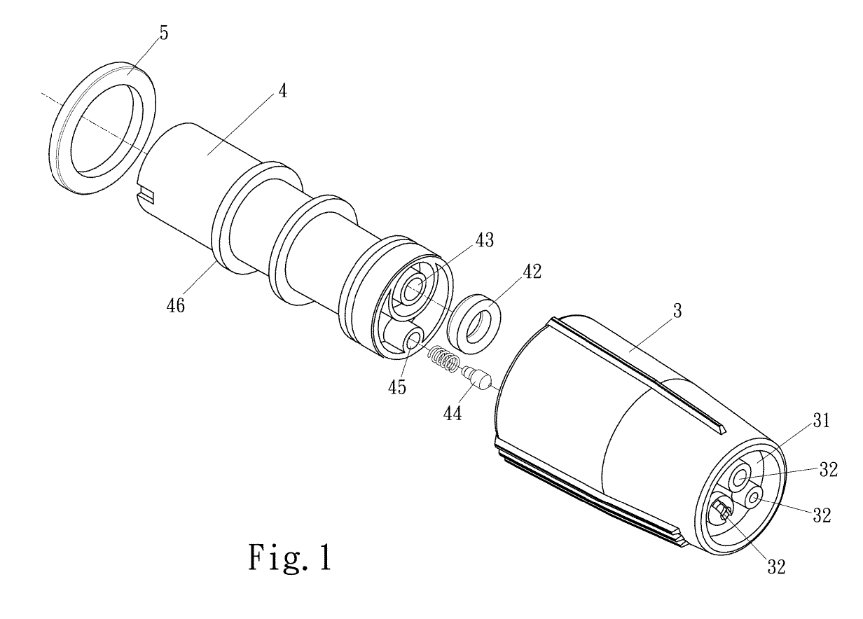

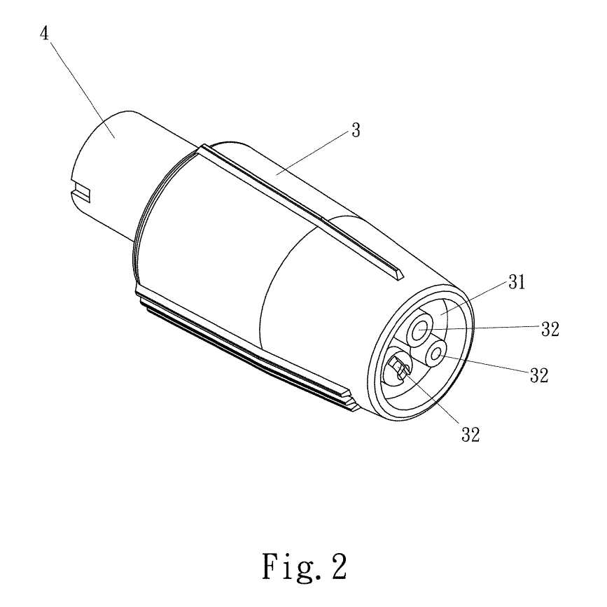

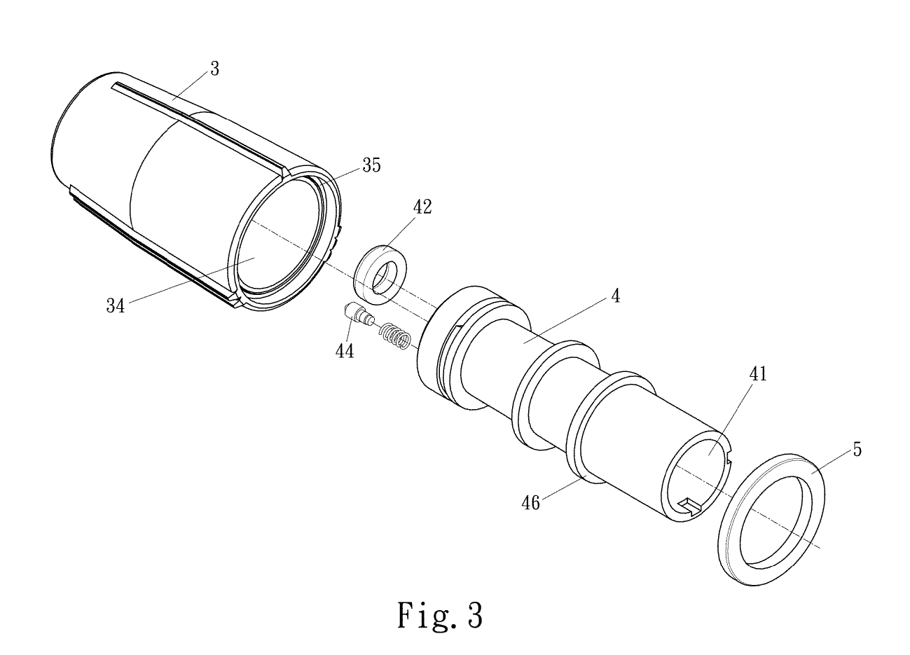

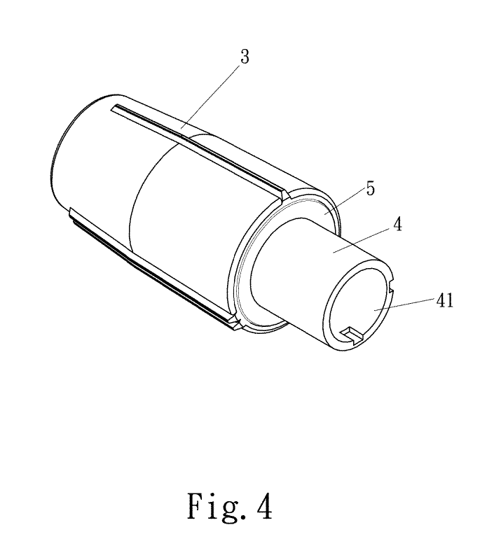

As shown in FIG. 1 through FIG. 6, the present invention discloses a coupling structure of a spray head 3 and a connector 4 of a water spray gun. A front end of the spray head 3 is connected with a circular plate 31. A central portion of the circular plate 31 is provided with a plurality of spray holes 32 which are arranged circularly and provide different spray modes. A rear side of the circular plate 31 is formed with positioning recesses 33 disposed at an outer side of each spray hole 32. A rear end of the spray head 3 is formed with an accommodation space 34 therein.

A front section of the connector 4 is inserted from the rear end of the spray head 3 into the accommodation space 34. The connector 4 has a water channel space 41 therein for communicating with a water source. A front end of the connector 4 has a water outlet 43 and a positioning hole 45. The water outlet 43 is sleeved with an elastic O-shaped sealing ring 42 and in communication with the water channel space 41. The positioning hole 45 is configured to receive a positioning pin 44. The positioning pin 44 is engaged in one of the positioning recesses 33 at the rear side of the spray head 3, enabling the spray head 3 to be rotated for adjustment. One of the spray holes 32 arranged at the central portion of the circular plate 31 is aligned with the water outlet 43 of the connector 4 and in contact with the elastic O-shaped sealing ring 42 so as to guide the water to spray out through the spray hole 32 of the spray head 3.

The present invention is characterized in that: an outer wall of the connector 4 is provided with a positioning flange 46. The rear end of the spray head 3 is provided with a stop plate 5. The rear end of the spray head 3 is further provided with a positioning rim 35. When the connector 4 is inserted into the accommodation space 34 at the rear end of the spray head 3, the stop plate 5 is secured in the positioning rim 35 and connected with the rear end of the spray head 3. (For example, the stop plate 5 is connected to the spray head 3 by ultrasonic, adhesive or a locking member.) The stop plate 5 has an annular area to get contact with the positioning flange 46 provided on the outer wall of the connector 4, such that the spray head 3 and the connector 4 are assembled to become one-piece.

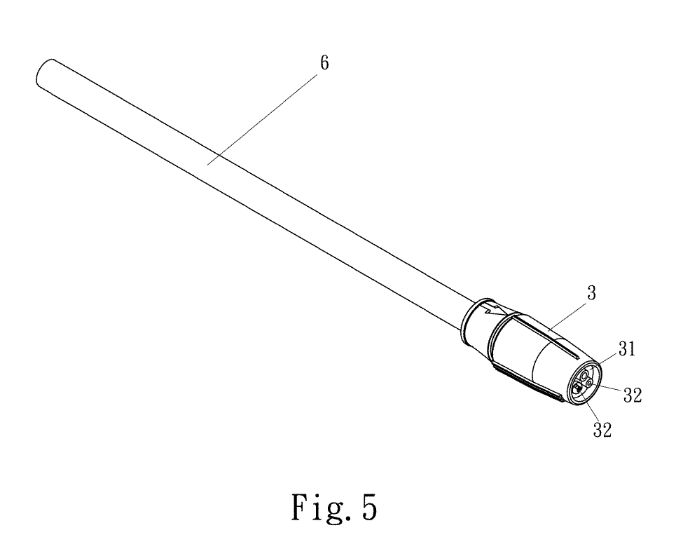

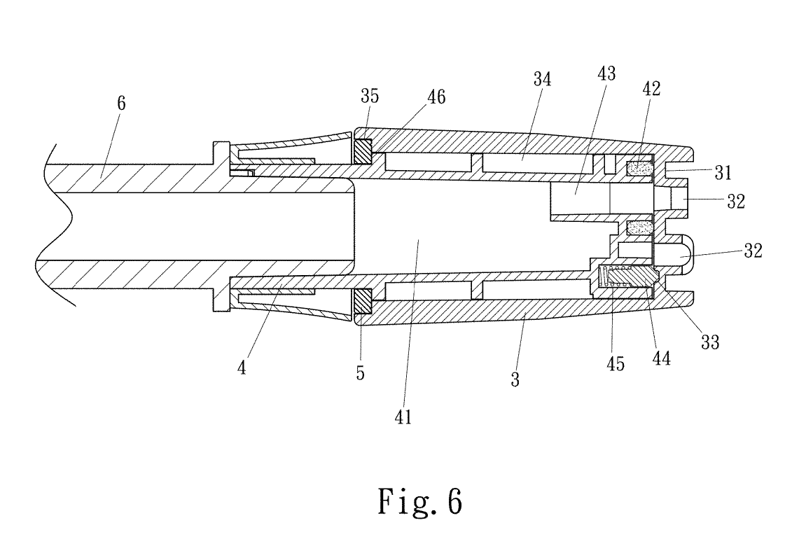

Referring to FIG. 5 and FIG. 6, the rear end and the interior of the connector 4 are hollow to connect with a front end of a water inlet connector 6 of a water spray gun (not shown in the drawings). The stop plate 5 has a larger annular area to get contact with the positioning flange 46 provided on the outer wall of the connector 4. The size of the spray head 3 is reduced, so it is light and cost-effective. When the user wants to adjust the spray head 3, each of the spray holes 32 disposed at the central portion of the circular plate 31 can be aligned with the water outlet 43 of the connector 4 and in contact with the elastic O-shaped sealing ring 42 so as to guide the water to spray out through the spray hole 32 of the spray head 3.

The present invention is to solve the shortcomings of the prior art and has obvious effects and advantages, not disclosed or published on the market.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A coupling structure of a spray head and a connector of a water spray gun,
a front end of the spray head being connected with a circular plate, a central portion of the circular plate being provided with a plurality of spray holes which are arranged circularly and provide different spray modes, a rear side of the circular plate being formed with positioning recesses disposed at an outer side of each spray hole, a rear end of the spray head being formed with an accommodation space therein;
a front section of the connector being inserted from the rear end of the spray head into the accommodation space, the connector having a water channel space therein for communicating with a water source, a front end of the connector having a water outlet and a positioning hole, the water outlet being sleeved with an elastic O-shaped sealing ring and in communication with the water channel space, the positioning hole being configured to receive a positioning pin, the positioning pin being engaged in one of the positioning recesses at the rear side of the spray head, enabling the spray head to be rotated for adjustment, one of the spray holes arranged at the central portion of the circular plate of the spray head being aligned with the water outlet of the connector and in contact with the elastic O-shaped sealing ring so as to guide water to spray out through the spray hole of the spray head; and
characterized by: an outer wall of the connector being provided with a positioning flange, the rear end of the spray head being provided with a stop plate, wherein when the connector is inserted into the accommodation space at the rear end of the spray head, the stop plate is connected with the rear end of the spray head, and the stop plate has an annular area to get contact with the positioning flange provided on the outer wall of the connector, such that the spray head and the connector are assembled to become one-piece.

2. The coupling structure of a spray head and a connector of a water spray gun as claimed in claim 1, wherein the rear end of the spray head is further provided with a positioning rim, wherein when the connector is inserted into the accommodation space at the rear end of the spray head, the stop plate is secured in the positioning rim and connected with the rear end of the spray head.

3. The coupling structure of a spray head and a connector of a water spray gun as claimed in claim 1, wherein the stop plate is connected to the rear end of the spray head by ultrasonic, adhesive or a locking member.
